(19) United States
(12) Patent Application Publication
(10) Pub. No.: US 2025/0269511 A1
(43) Pub. Date: Aug. 28, 2025

(54) COLLAPSIBLE WORKBENCH WITH LOCKING DEVICE

(71) Applicant: E-MAKE Co.,Ltd., Taichung City (TW)

(72) Inventors: Kung-Cheng Chen, Taichung City (TW); Lung-Chuan Huang, Taichung City (TW)

(21) Appl. No.: 18/589,978

(22) Filed: Feb. 28, 2024

(51) Int. Cl. B25H 1/02; B25H 1/14

(52) U.S. Cl. CPC B25H 1/02; B25H 1/14

(57) ABSTRACT

A collapsible workbench includes a parallelepiped casing including two rails disposed on two inner surfaces of two sides respectively; and a door; a table assembly including two slides having a first slide member slidably disposed on the rail and a second slide member slidably disposed on an inner surface of the first slide member; and a multipart table including a rectangular first sub-table disposed on the first slide members, and a rectangular second sub-table hingedly secured onto the first sub-table; and two locking devices including a front handle having a forward extension; a rear lock having a concave member; and a pivot pivotably secured to either side of a rear end of the first sub-table. The rear lock is heavier than the front handle. A pivotal movement of the extension causes a front end of the rail to be locked or unlocked by the concave member.

### FIELD OF THE INVENTION

The invention relates to workbenches and more particularly to a collapsible workbench having a pivotal locking device for fastening the workbench in a fully extended position in use.

### BACKGROUND OF THE INVENTION

Conventional workbenches occupy a large space in order to achieve a stable support effect. However, this design has problems (e.g., inconvenient movement and space occupation), which make it difficult for the workbench to easily move during operation. To the worse, it is bulky. And in turn, it adversely affects effectiveness of the precious space, utilization and arrangement of work flow. As a result, work efficiency is greatly decreased.

Thus, the need for improvement still exists.

### SUMMARY OF THE INVENTION

It is therefore one object of the invention to provide a collapsible workbench comprising a parallelepiped casing including two rails disposed on two inner surfaces of two sides respectively; and a door hingedly secured to a lower edge of a front opening; a table assembly including two slides having a first slide member lidably disposed on the rail and a second slide member slidably disposed on an inner surface of the first slide member; a limit member disposed on front ends of the second slide members; and a multipart table including a rectangular first sub-table disposed on the first slide members, and a rectangular second sub-table hingedly secured onto the first sub-table wherein in a fully extended position the second sub-table is disposed on the second slide members, and stopped by the limit member; and two locking devices including a front handle having a forward extension; a rear lock having a concave member; and a pivot pivotably secured to either side of a rear end of the first sub-table and disposed above the rail wherein a pivotal movement of the extension is configured to cause a front end of the rail to be locked by the concave member of the rear lock.

The above and other objects, features and advantages of the invention will become apparent from the following detailed description taken with the accompanying drawings

### BRIEF DESCRIPTION OF THE DRAWINGS

FIG. 1 is a perspective view of a collapsible workbench according to the invention;

FIG. 2 is a perspective view of the collapsible workbench with the door open;

FIG. 3 is a perspective view of the collapsible workbench with the multipart table extended out of the workbench by pulling;

FIG. 4 is a view similar to FIG. 3 with the slide further extended out of the workbench by pulling in an unlocked position;

FIG. 5 is a schematic longitudinal sectional view of FIG. 4;

FIG. 6 is a detailed view of the area in a rectangle of FIG. 5;

FIG. 7 is a perspective view of the collapsible workbench with the multipart table fully extended and secured in a locked position;

FIG. 8 is a schematic longitudinal sectional view of FIG. 7;

FIG. 9 is a detailed view of the area in a rectangle of FIG. 8;

FIG. 10 is a perspective view of the collapsible workbench mounted on a cabinet; and

FIG. 11 is a schematic longitudinal sectional view of FIG. 10 with a joining portion of the casing and the cabinet shown in details.

### DETAILED DESCRIPTION OF THE INVENTION

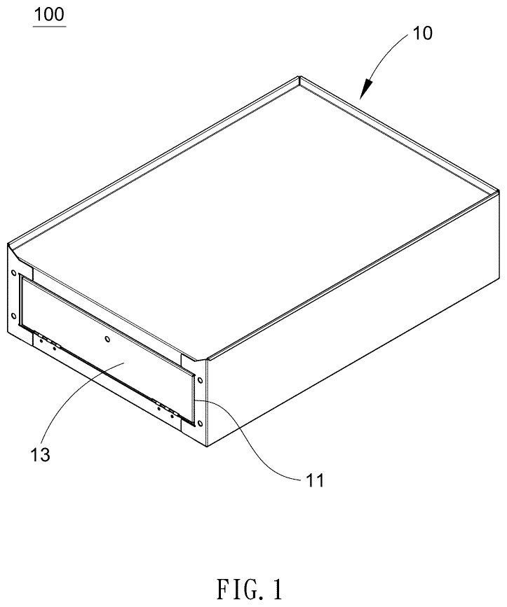

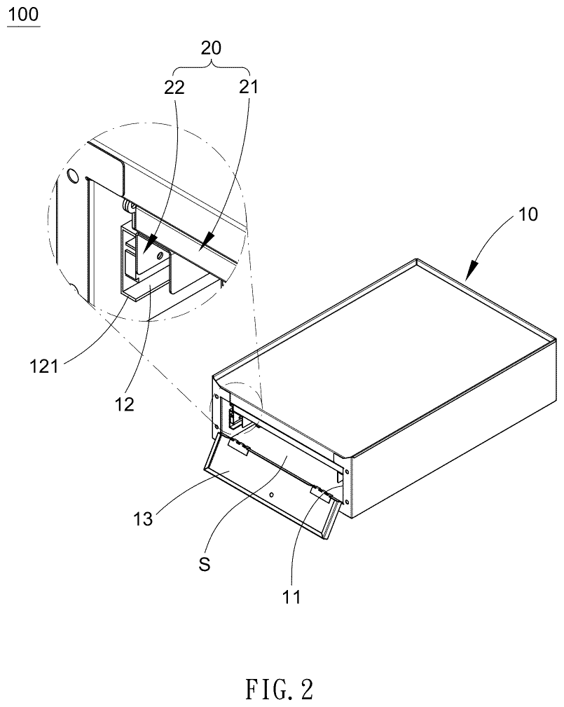

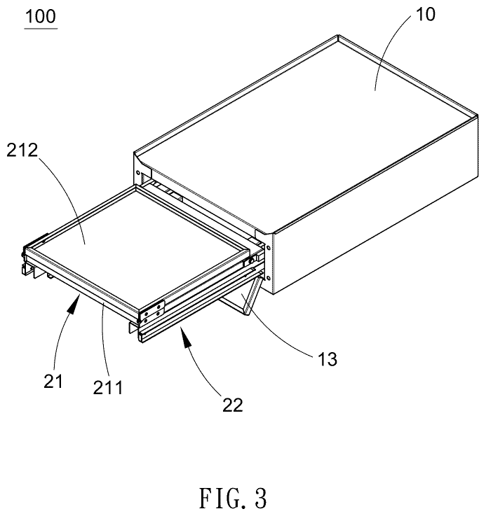

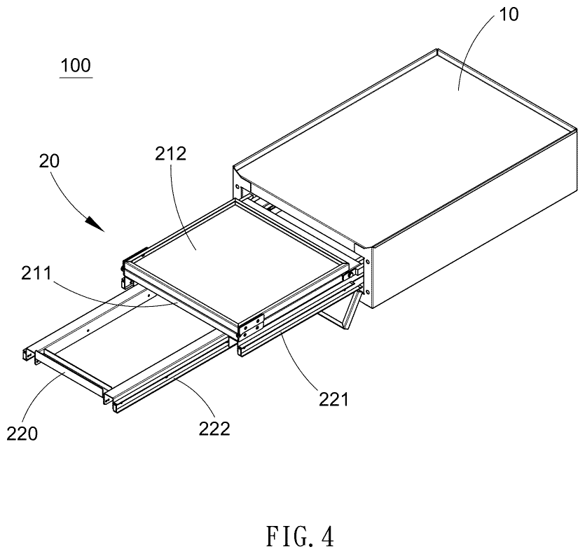

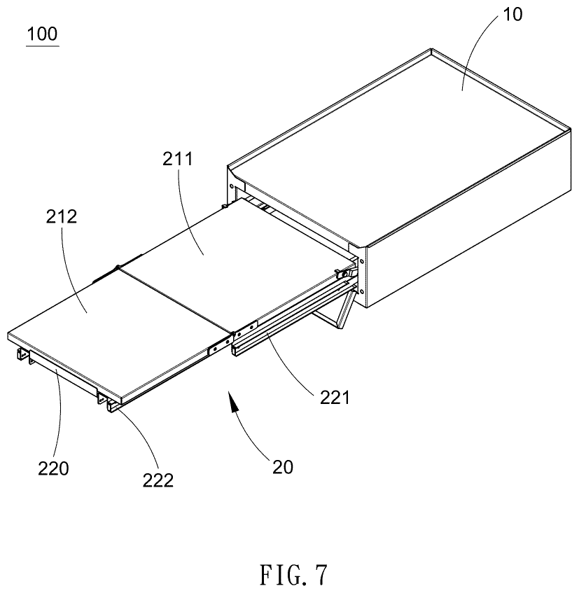

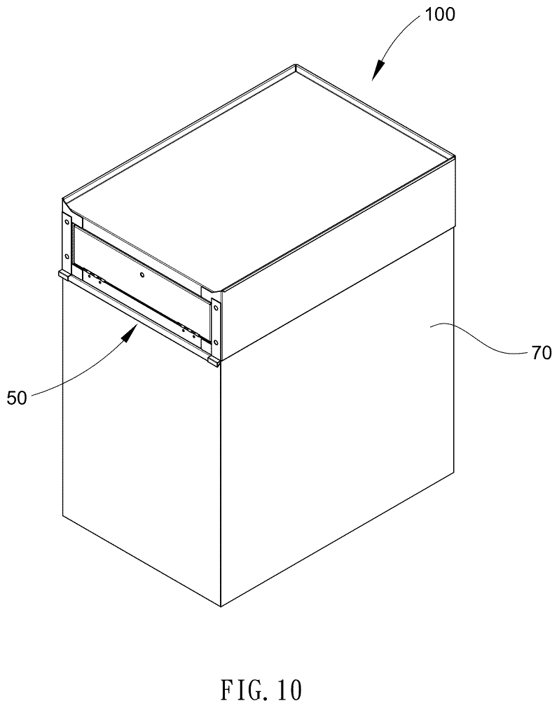

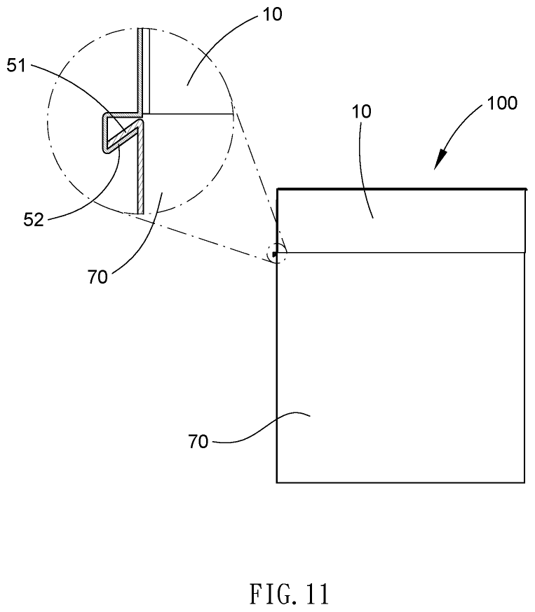

Referring to FIGS. 1 to 11, a collapsible workbench 100 in accordance with the invention is mounted on a cabinet 70 and comprises a casing 10, a table assembly 20, and two locking devices 30 as discussed in detail below.

The casing 10 includes a space S; two rails 12 disposed on two inner surfaces of two sides respectively, the rail 12 having a front end 121 and a rear end 122; an opening 11; and a door 13 hingedly secured to a lower edge of the opening 11.

The table assembly 20 includes two slides 22 having a first slide member 221 slidably disposed on the rail 12 and a second slide member 222 slidably disposed on an inner surface of the first slide member 221; a limit member 220 disposed on front ends of the second slide members 222; and a multipart table 21 secured to the slides 22. Thus, the table assembly 20 may extend out of the space S in a use position or retract into the space S in a storage position.

The multipart table 21 includes a first sub-table 211 disposed on the first slide members 221, and a second sub-table 212 hingedly secured onto the first sub-table 211. The second sub-table 212 is disposed on the second slide members 222 by pivoting. At this position, the second sub-table 212 is engaged with and stopped by the limit member 220. Thus, the multipart table 21 is fully extended.

The locking device 30 includes a front handle 31 having a forward extension 311; a rear lock 32; and a pivot 33 pivotably secured to either side of a rear end of the first sub-table 211 and above the front end 121 of the rail 12.

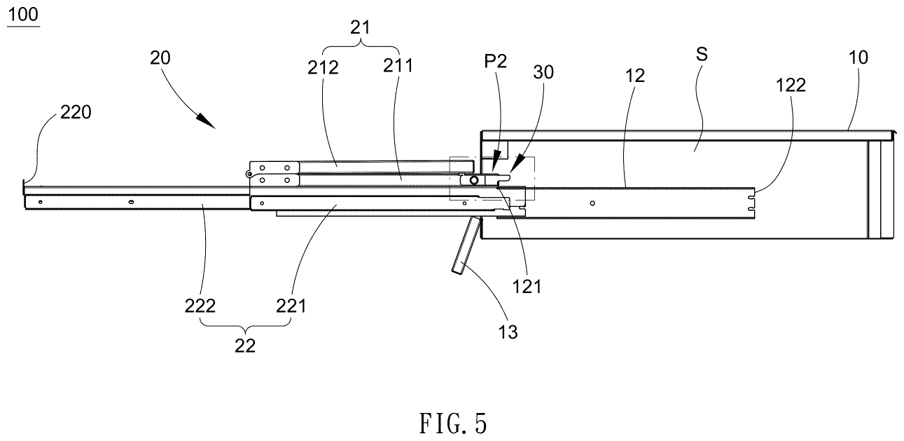

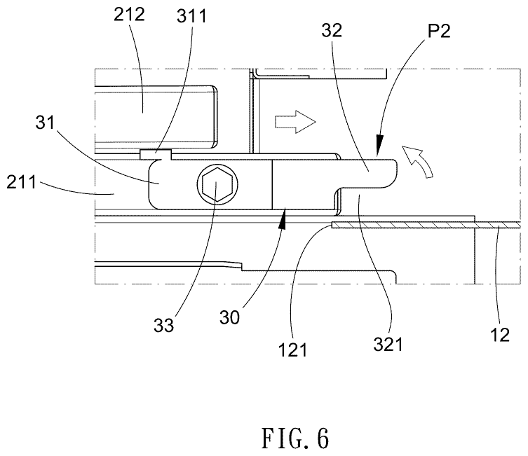

As shown in FIGS. 5 and 6 specifically, a user may press down the extension 311 to counterclockwise pivot the locking device 30 about the pivot 33 until the locking device 30 is disposed horizontally and the front end 121 of the rail 12 is not locked by a concave member 321 of the rear lock 32 in an unlocked position as indicated by P2. Next, the user may push the table assembly 20 into the space S for storage.

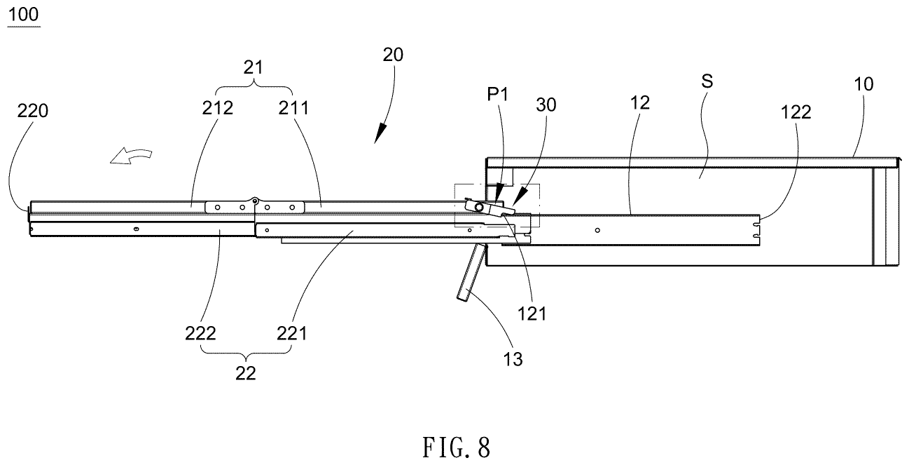

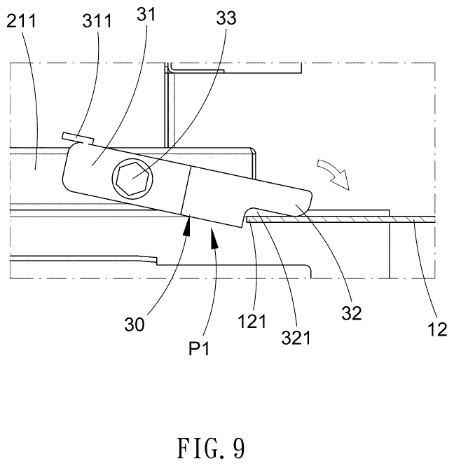

As shown in FIGS. 8 and 9 specifically, after the table assembly 20 is fully extended, the rear lock 32 automatically clockwise pivots about the pivot 33 because the rear lock 32 is heavier than the front handle 31 until the concave member 321 of the rear lock 32 is urged by the front end 121 of the rail 12 in a locked position as indicated by P1. As a result, the table assembly 20 is locked.

A fastening device 50 includes a first member 51 formed with the cabinet 70 and a second member 52 formed with the casing 10. The fastening device 50 may secure the casing 10 to the cabinet 70.

While the invention has been described in terms of preferred embodiments, those skilled in the art will recognize that the invention can be practiced with modifications within the spirit and scope of the appended claims.

What is claimed is:

1. A collapsible workbench, comprising:
a parallelepiped casing including two rails disposed on two inner surfaces of two sides respectively; and a door;
a table assembly including two slides having a first slide member slidably disposed on the rail and a second slide member slidably disposed on an inner surface of the first slide member; a limit member disposed on front ends of the second slide members; and a multipart table including a rectangular first sub-table disposed on the first slide members, and a rectangular second sub-table hingedly secured onto the first sub-table; and
two locking devices including a front handle having a forward extension; a rear lock having a concave member; and a pivot pivotably secured to either side of a rear end of the first sub-table and disposed above the rail.

2. The workbench of claim 1, wherein in a fully extended position the second sub-table is disposed on the second slide members and stopped by the limit member.

3. The workbench of claim 1, wherein the rear lock is heavier than the front handle.

4. The workbench of claim 1, wherein a clockwise pivotal movement of the forward extension is configured to cause a front end of the rail to be locked by the concave member.

5. The workbench of claim 4, wherein a counterclockwise pivotal movement of the forward extension is configured to unlock the front end of the rail.
